(19) United States
(12) Patent Application Publication
(10) Pub. No.: US 2026/0030688 A1
(43) Pub. Date: Jan. 29, 2026

(54) AUTOMATED DOCUMENT IDENTIFICATION AND AUDITING SYSTEM

(71) Applicant: DEALR, INC., Loveland, CO (US)

(72) Inventors: Forrest MIDDLETON, Johnstown, CO (US); Thomas BOTTAGARO, Boulder, CO (US)

(21) Appl. No.: 19/284,020

(22) Filed: Jul. 29, 2025

Related U.S. Application Data
(60) Provisional application No. 63/676,826, filed on Jul. 29, 2024.

(51) Int. Cl. G06Q 40/12; G06V 10/32; G06V 30/413

(52) U.S. Cl. CPC G06Q 40/124; G06V 10/32; G06V 30/413

(57) ABSTRACT

An auditing system may process documents associated with a transaction to audit the entire transaction or the documents involved in the transaction. The documents are received and classified by document types. Structured text, unstructured text or both are extracted from the documents and structured data is produced using the extracted text. The documents are audited using the structured data. In some embodiments, the documents may be audited using structured auditing questions, automated programmatic verification, external data sources, or combinations thereof.

### CROSS-REFERENCE TO RELATED APPLICATION

This application claims the filing benefit of U.S. Provisional Application No. 63/676,826, filed Jul. 29, 2024. This application is incorporated by reference herein in its entirety and for all purposes.

### FIELD

The present disclosure relates generally to systems for identifying and auditing transaction documents.

### BACKGROUND

Auditing of transaction documents is often completed manually. For example, verification of documents associated with vehicle purchases and mortgage transactions may be completed manually by a specially trained person having to review various documents individually to identify issues and record the transaction (e.g., recordation with the state or other jurisdiction). For example, data entry for departments of motor vehicles within a state is a manual process whereby a professional reads printed documents (either in hard copy or digital copy) and inputs data corresponding to a vehicle transaction into the state's database. Auditing such transactions similarly can be a time-consuming process and may require specially trained auditors that need to review documents individually as well as the manually created records associated with the transaction. As a result, only a small portion of transaction documents may be audited or otherwise reviewed for errors, leading to errors in transaction documents, which may have negative ramifications. For example, DMV auditors may have a checklist of entries to verify but may omit certain points on the check list or simply overlook mismatches of data or other errors.

### SUMMARY

A computer-implemented method includes receiving, from a computing device, a transaction package including a plurality of documents associated with a single transaction and separating the plurality of documents into individual pages. At least a portion of the individual pages are converted into a common format. In one embodiment, the common format may be an image format. The individual pages are classified by document type and text is extracted from at least a portion of the individual pages to produce extracted text. In some instances, the text may be extracted using one or more extraction algorithms trained to extract text from documents associated with the document type. Structured data is generated using the extracted text. The structured data may be generated by normalizing data corresponding to data fields across the individual pages. Prior to separating the plurality of documents into the individual pages, a user interface may be transmitted to a computing device. The user interface may be configured to display at least a preview of each of the individual pages, and the previews arranged by document type.

A computer-implemented method includes receiving, from a computing device, a transaction package including a plurality of documents associated with a single transaction and separating, by a processor, the plurality of documents into individual pages. At least a portion of the individual pages are converted into a common format by the processor. In one embodiment, the common format may be an image format. The individual pages are classified by document type by the processor and text is extracted from at least a portion of the individual pages by the processor to produce extracted text. In some instances, the text may be extracted using one or more extraction algorithms trained to extract text from documents associated with the document type. Structured data is generated by the processor using the extracted text. The structured data may be generated by normalizing data corresponding to data fields across the individual pages. Prior to separating the plurality of documents into the individual pages, a user interface is transmitted to a computing device. The user interface may be configured to display at least a thumbnail image of each of the individual pages, the thumbnail images arranged by document type, and a visual status indicator for each of the separating operation and the classifying operation. An appearance of each of the visual status indicators changes between initialization of the separating operation and the classifying operation and completion of the separating operation and the classifying operation.

A system includes one or more processors and one or more memories. The one or more memories store instructions, that when executed by at least one processor of the one or more processors, cause operations to be performed. The operations include receiving document package including a plurality of documents associated with a single transaction and separating the plurality of documents into individual pages. At least a portion of the individual pages are converted into a common format. In one embodiment, the common format may be an image format. The individual pages are classified by document type and text is extracted from at least a portion of the individual pages to produce extracted text. In some instances, the text may be extracted using one or more extraction algorithms trained to extract text from documents associated with the document type, and at least one of the one or more extraction algorithms is an image classifier. Structured data is generated using the extracted text. The structured data may be generated by normalizing data corresponding to data fields across the individual pages. Prior to separating the plurality of documents into the individual pages, a user interface is transmitted to a computing device. The user interface may be configured to display at least a preview of each of the individual pages, the previews arranged by document type, and a visual status indicator for each of the separating operation and the classifying operation. An appearance of each of the visual status indicators changes between initialization of the separating operation and the classifying operation and completion of the separating operation and the classifying operation by changing at least one of a color of the visual status indicator, a weight of an outline of the visual status indicator, a shape of the visual indicator, or a design of the visual indicator.

A computer-implemented method includes receiving a transaction package including a plurality of transaction documents associated with a single transaction, classifying one or more of the plurality of transaction documents as types of transaction documents, and generating structured data from the transaction documents by normalizing data corresponding to data fields across the plurality of transaction documents based on a hierarchy of transaction documents within the plurality of transaction documents.

In some examples, the method further includes auditing the transaction documents using the structured data, where auditing the transaction documents includes presenting one or more structured data questions, verifying that the structured data matches data in the plurality of transaction documents, and where the structured data does not match the data in at least one of the plurality of transaction documents, notifying a user.

In some examples, generating the structured data includes extracting text from the plurality of transaction documents based on the types of transaction documents.

In some examples, generating the structured data includes comparing text extracted from two or more of the plurality of transaction documents.

In some examples, classifying the plurality of transaction documents includes splitting the transaction package into the plurality of transaction documents.

In some examples, the single transaction is one of a mortgage transaction and a vehicle sale.

A computer implemented method includes classifying a plurality of transaction documents using a machine learning model trained to identify a plurality of types of documents associated with a single transaction, extracting text from the plurality of transaction documents using one or more models trained to extract text from data fields of the plurality of types of documents, and normalizing the extracted text across the plurality of transaction documents to generate structured data, where the extracted text is normalized based on a hierarchy of transaction documents within the plurality of transaction documents.

In some examples, the method further includes identifying an error in the plurality of transaction documents based on a response to a structured auditing questions, and where the error exceeds a risk threshold, presenting the error to a user.

In some examples, the method further includes verifying that the structured data matches data in the plurality of transaction documents.

In some examples, the machine learning model is an image classifier.

In some examples, normalizing the extracted text across the plurality of transaction documents includes comparing the extracted text from two or more of the plurality of transaction documents.

In some examples, classifying the plurality of transaction documents includes splitting the transaction package into the plurality of transaction documents.

In some examples, the single transaction may be one of a mortgage transaction or a vehicle sale.

One or more non-transitory computer readable media encode instructions which, when executed by one or more processors of an auditing system, cause the auditing system to receive a transaction package including a plurality of transaction documents associated with a single transaction, classify each of the plurality of transaction documents as a respective type of transaction document, and generate structured data from the transaction documents by normalizing data across the plurality of transaction documents by normalizing data across the plurality of transaction documents based on a hierarchy of transaction documents within the plurality of transaction documents.

In some examples, the instructions further cause the auditing system to audit the transaction documents using the structured data, where auditing the transaction documents includes presenting one or more structured auditing questions.

In some examples, auditing the transaction documents includes verifying that the structured data matches data in the plurality of transaction documents and where the structured data does not match the data in at least one of the plurality of transaction documents, notifying a user.

In some examples, generating the structured data includes extracting text from the plurality of transaction documents based on the types of transaction documents.

In some examples, generating the structured data includes comparing text extracted from two or more of the plurality of transaction documents.

In some examples, classifying the plurality of transaction documents includes splitting the transaction package into the plurality of transaction documents.

In some examples, the single transaction may be one of a mortgage transaction or a vehicle sale.

A computer implemented method includes classifying a transaction document as a type of document using a machine learning model trained to identify a plurality of types of documents, extracting text from the transaction document using a model trained to extract text from data fields of the type of document, generating structured data from the extracted text, identifying an error in the transaction document based on a response to a structured auditing question, where the structured auditing question is presented based on the type of document, and where the error exceeds a risk threshold, presenting the error to a user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 illustrates an example auditing system in communication with various computing systems according to an embodiment of the disclosure.

FIG. 2 is a schematic diagram of an example auditing system according to an embodiment of the disclosure.

FIG. 3 is an example user interface of the auditing system according to an embodiment of the disclosure.

FIG. 4 is an additional example user interface of the auditing system according to an embodiment of the disclosure.

FIG. 5 is an additional example user interface of the auditing system according to an embodiment of the disclosure.

FIG. 6 is an additional example user interface of the auditing system according to an embodiment of the disclosure.

FIG. 7 is an additional example user interface of the auditing system according to an embodiment of the disclosure.

FIG. 8 is an additional example user interface of the auditing system according to an embodiment of the disclosure.

FIG. 9 is an additional example user interface of the auditing system according to an embodiment of the disclosure.

FIG. 10 is an additional example user interface of the auditing system according to an embodiment of the disclosure.

FIG. 11 is an additional example user interface of the auditing system according to an embodiment of the disclosure.

FIG. 12 is a schematic diagram of an example computer system implementing various embodiments in the examples described herein.

FIG. 13 illustrates an example process for identifying and auditing a document package using an auditing system according to an embodiment of the disclosure.

FIG. 14 illustrates an example process for auditing a document package using an auditing system according to an embodiment of the disclosure.

### DETAILED DESCRIPTION

Financial and legal transactions (e.g., car sales or transfers, mortgages, liens or the like) generally generate a variety of transaction documents that are often recorded with a particular database, such as a state or city department, bank, private uses, or the like. Because each transaction often may include multiple separate, yet related documents, many of which are completed manually, and the entry into a database is typically via manual entry, this can lead to errors. For example, errors can be generated during the document execution stage where people simply complete or add in information incorrectly in one or more documents, include information in different formats across different documents of the transaction, or the like. Such errors can create a downstream impact as the database, such as a state property record database or DMV database can be controlling for further transactions or the like.

Auditing transactions, such as those that have been entered into a database, may generally be a cumbersome process, including manually cross-checking data across various documents. Further, such auditing may generally be carried out by users specifically trained to audit documents in a particular industry, as specific elements of the data or documents may be more important in various industries or types of transactions. Additionally, some types of errors may not be identified by a process of only checking that data matches across the transaction documents. Due to the burden of fully auditing such transaction document packages, only a small percentage of the transaction documents may be audited, leading to persistent errors in the transaction documents.

The auditing system described herein may be utilized to perform more efficient audits of a transaction and transaction documents related to the transaction. In one aspect, the auditing system may process documents in document packages to generate structured data that may be used in auditing both the entire transaction (e.g., to ensure that the transaction record is correct) as well as auditing the documents themselves. Such structured data may be generated using industry or transaction specific document hierarchies, such that the structured data is most likely to be accurate for use in the auditing process. In various examples, the auditing system may further be utilized to perform audits of transaction documents and/or other types of documents (collectively referred to as transaction details). The auditing system may provide both automatic programmatic verification of information in the documents as well as guiding user review of the documents utilizing structured auditing questions that are specific to the transaction details. Accordingly, auditing of such transaction documents may be completed more quickly, and audits may be more accurate, leading to transaction documents with fewer errors.

A transaction may be, for example, a sales transaction (e.g., a vehicle sale), a financial transaction (e.g., a mortgage transaction), or the like. Generally, a transaction includes a number of interrelated, but distinct, transaction documents. Such transaction documents may include the same or similar data. The transaction may further be associated with a transaction record generated to document the transaction based on data in the various documents. The auditing system described herein may be used to audit transaction documents and/or the transaction record.

While the auditing system is generally described with respect to sales or other financial transactions, the auditing system may be used to audit other types of documents in various examples. For example, the auditing system may be utilized to perform audits of medical records, educational records, or the like. Similar to transaction documents, the auditing system may be utilized to identify errors in such documents using industry and/or document specific auditing procedures. In such examples, the auditing system may be used to identify errors in documents that may not otherwise be manually audited.

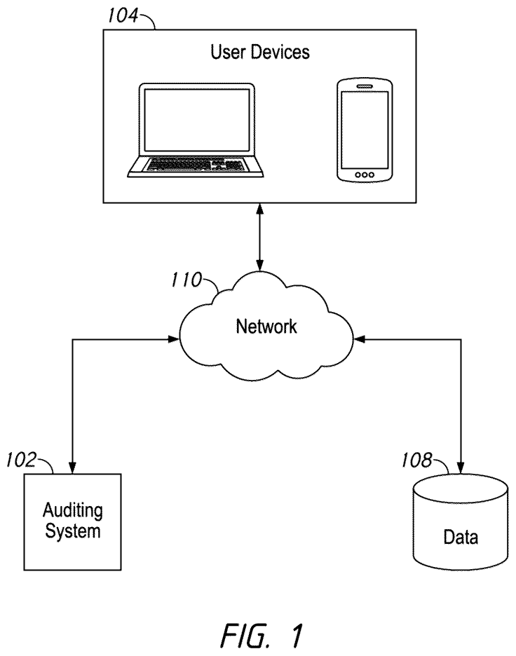

FIG. 1 illustrates an example auditing system in communication with various computing systems according to an embodiment of the disclosure. The auditing system 102 may be generally implemented by a computing device or combinations of computing resources in various embodiments. In various examples, the auditing system 102 may be implemented by one or more servers, cloud computing resources, and/or other computing devices. The auditing system 102 may, for example, utilize various processing resources to identify and audit transaction documents. The auditing system 102 may further include memory and/or storage locations to store program instructions for execution by the processor and various data utilized by the auditing system 102.

User devices 104 and/or other user devices in communication with the auditing system 102 may be devices belonging to an end user utilizing the auditing system 102, such as, in various examples, users associated with transactions. In FIG. 1, two example user devices 104 are shown (e.g., a laptop computer and a smart phone). Example users that may be associated with transactions include, but are not limited to, employees at car dealerships, title agents, mortgage brokers, insurance agents, and other users associated with various types of financial transactions. In various embodiments, user devices 104 may be authenticated by an authentication service prior to accessing the auditing system 102. Further, user devices 104 may be associated with different types of permissions for accessing the auditing system 102. For example, some user devices 104 may have permission to upload document packages and perform audits using the auditing system 102, while other user devices 104 may have permission to generate structured data from uploaded document packages without completing the auditing process through the auditing system 102.

In various embodiments, user devices 104 and/or other user devices in communication with the auditing system 102 may be implemented using any number of computing devices including, but not limited to, a computer, a laptop, mobile phone, smart phone, wearable device (e.g., AR/VR headset, smart watch, smart glasses, or the like), smart speaker, vehicle (e.g., automobile), or appliance. Generally, the user devices 104 may include one or more processors, such as a central processing unit (CPU) and/or graphics processing unit (GPU). The user devices 104 may generally perform operations by executing processor-executable instructions (e.g., software) using the processor(s).

The auditing system 102 may be in communication with various data stores in various embodiments. For example, the auditing system 102 may be in communication with a data store 108. In various examples, the data store 108 may store models utilized by the auditing system 102 and data utilized by the auditing system (e.g., user data). The data store 108 may be any type of data storage including cloud or remote storage locations or local storage locations. In some examples, data store 108 may be distributed over multiple storage locations.

The auditing system 102 generally communicates with other computing systems and/or data stores via a network 110. The network 110 may be implemented using one or more of various systems and protocols for communications between computing devices. In various embodiments, the network 110 or various portions of the network 110 may be implemented using the Internet, a local area network (LAN), a wide area network (WAN), and/or other networks. In addition to traditional data networking protocols, in some embodiments, data may be communicated according to protocols and/or standards including near field communication (NFC), BLUETOOTH®, cellular connections, and the like.

Components of the auditing system 102 and in communication with the auditing system 102 are exemplary and may vary in some embodiments. For example, in some embodiments, the auditing system 102 may be implemented as a monolithic computing system (e.g., a monolithic server), as a distributed computing system, any combination thereof, and the like. For example, the auditing system 102 may be distributed across multiple computing elements, such that components of the auditing system 102 communicate with one another through the network 110. Further, the auditing system 102 and/or components of the auditing system 102 may configure and/or instruct jobs to run on other computing devices, including various serverless jobs, configuration of containers, and the like. Further, in some embodiments, computing resources dedicated to the auditing system 102 may vary over time based on one or more factors, such as usage of the auditing system 102. In some embodiments, the auditing system 102 may communicate with external user devices 104 and/or other systems not shown in FIG. 1.

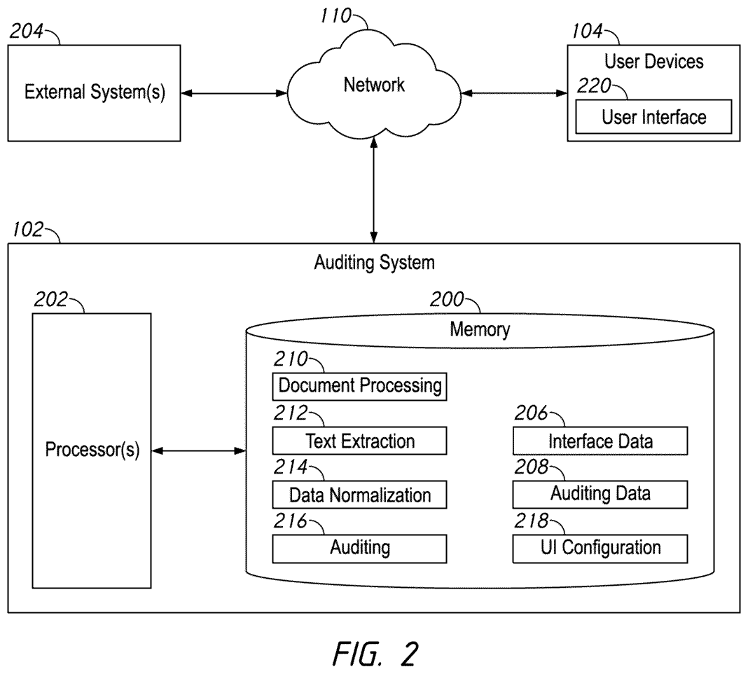

FIG. 2 is a schematic diagram of an example auditing system 102 according to an embodiment of the disclosure. The auditing system 102 generally categorizes documents within a document package and generates structured data from the documents by utilizing a hierarchy across the documents. In some examples, the auditing system 102 may further be utilized to conduct audits to identify errors in the documents in the document package, as described in further detail herein.

In various examples, the auditing system 102 may include or utilize one or more hosts or combinations of compute resources, which may be located, for example, at one or more servers, cloud computing platforms, computing clusters, and the like. Generally, the auditing system 102 may be implemented by compute resources at one or more servers, computing devices, and/or across a serverless architecture. The auditing system 102 may generally be implemented by compute resources including hardware for memory 200 and one or more processors 202. For example, the auditing system 102 may utilize or include one or more processors, such as a CPU, GPU and/or programmable or configurable logic.

In some embodiments, various components of the auditing system 102 may be distributed across various computing resources, such that components of the auditing system 102 communicate with one another through the network 110 and/or using other communications protocols. For example, in some embodiments, the auditing system 102 may be implemented as a serverless service, where computing resources for various components of the auditing system 102 may be located across various computing environments (e.g., cloud platforms) and may be reallocated dynamically and/or automatically according to, for example, resource usage of the auditing system 102. In various implementations, the auditing system may be implemented using organizational processing constructs such as functions implemented by worker elements allocated with compute resources, containers, virtual machines, and the like.

The auditing system 102 may further communicate with various data stores storing data utilized by the auditing system 102. Such data stores may be located at the same or separate computing environments as the auditing system 102.

The auditing system 102 may further communicate with various external systems 204 via the network 110. Such external systems 204 may, in various embodiments, be utilized to verify and/or normalize data. For example, such external systems 204 may be databases associated with government entities (e.g., the postal service, department of motor vehicles, or the like) and/or other organizations. In some examples, such external systems 204 may include trained machine learning models or services utilized by the auditing system 102 to generate structured data for document packages and/or to audit document packages.

In various examples, memory 200 of the auditing system 102 may be implemented as persistent and/or volatile memory that store various types of data. For example, memory 200 may store interface data 206 and auditing data 208. Interface data 206 may generally be data used to access external systems (e.g., external system 204) in communication with the auditing system 102. Such data may include, in various examples, access credentials, pre-formatted API calls, and the like. Auditing data may include, in various examples, particular structured auditing questions, risk tolerances, user specific settings of the auditing system 102, and the like.

The memory 200 may further include (e.g., store or access) instructions for various functions of the auditing system 102 which, when executed by processor 202, perform various functions of the auditing system 102. The memory 200 may further store data and/or instructions for retrieving data used by the auditing system 102. Similar to the processor 202, memory resources utilized by the auditing system 102 may be distributed across various physical computing devices. In some examples, memory 200 may access instructions and/or data from other devices or locations, and such instructions and/or data may be read into memory 200 to implement the auditing system 102.

In various embodiments, memory 200 may store instructions for document processing 210. Document processing 210 may generally classify documents within a larger transaction package or document package. For example, document processing 210 may separate or divide the document package into individual pages and determine which type of document each page belongs to. For example, a document package may be associated with a real estate purchase, such as the purchase of a home. The auditing system 102 may receive the document package and document processing 102 may separate the document package into individual pages and determine which pages belong to the purchase agreement, the deed, the title documents, the mortgage documents, the home inspection report, the appraisal report, and the title insurance policy.

Generally, document processing 210 may receive a document package or transaction package. Such a document package may, in some examples, include multiple documents related to one financial transaction, sales transaction, or the like. For example, a document package associated with a vehicle sale may include a title, a bill of sale, a tax receipt, a title application, a security agreement, and/or other documents related to the vehicle sale. Such document packages may be uploaded by a user (e.g., from a user device 104) to the auditing system 102 and may be in various file formats, including, for example, portable document format (PDF) or various image formats.

In various examples, document processing 210 may identify single documents within the document package. That is, document processing 210 may split the document package into individual documents. Such individual documents may be, in various examples, distinct documents that are all related to a transaction. Individual documents in a document package may include some overlapping information, which may be in the same or different formats. For example, multiple individual documents within a document package may include a customer name, vehicle, purchase price, or other similar information.

In some examples, document processing 210 may use page boundaries to locate individual pages within a document package. In some examples, document processing 210 may split the document package into individual documents and classify the individual pages as belonging to a particular type of document. For example, document processing 210 may locate individual pages and use a trained machine learned (ML) model to determine which type of document the page belongs to. In such examples, document processing 210 includes a machine learned model (e.g., an image classifier) trained to identify pages of particular types of documents within a document package. By considering each page individually, document processing 210 may accurately process document packages even when the pages of various documents are not contiguous within the document package.

A machine learned model trained to identify and classify documents within a document package may, in various examples, be an industry or transaction specific model trained on particular document types. For example, such a model may be a classifier trained using labeled datasets including examples of the types of documents to be identified by document processing 210. Accordingly, such models may be industry specific, location specific, or otherwise tailored for specific types of transactions (collectively referred to as transaction specific). For example, a model for vehicle sales may be trained to recognize title applications, titles, and other documents for one or more states or jurisdictions. Because the models are trained to be transaction specific, such models may more accurately classify documents and may utilize less storage and processing resources when compared to general purpose models.

In some examples, document processing 210 may further recognize when a document in the document package is incomplete, duplicated, or the like. Document processing 210 may further recognize when documents are incorrectly included in the document package. For example, document processing 210 may recognize that a particular type of document should be five pages in total. Where document processing 210 recognizes only four pages of the document, an error message may be transmitted to a user device (e.g., user device 104) indicating that one page of the document is missing from the document package. In another example, document processing 210 may recognize that a particular type of document should be five pages in total. Where document processing 210 recognizes that the document has a different number of pages, a similar message may be transmitted to the user device.

In various embodiments, memory 200 may store instructions for text extraction 212. Text extraction 212 may generally obtain text from documents within the document package. Each document includes static content that may be analyzed. For example, a document may be a written (text-based) document, an image such as a screenshot or a PDF document, one or more frames of a video, a visual page displayed on a computer and filled out using the computer, and other such documents. Structured text or unstructured text may be presented in a table. In various examples, text extraction 212 may extract structured text using, for example, key value pairs from various fields of the documents in the document package. Additionally or alternatively, text extraction 212 may extract unstructured text, such as raw text that is analyzed to produce conclusions about the unstructured text. The extracted structured text and unstructured text may also be referred to as extracted text.

Text extraction 212 may further utilize key value mapping for a many to one relationship. In various examples, text extraction 212 may include custom extraction models trained to extract extracted text (e.g., key value pairs) from various types of documents. Specifically, such models may be trained to extract data from specific fields of various documents or to extract raw text and analyze the text. In some examples, such extraction models may be specific to a document type. For example, an extraction model may be trained to extract particular key value pairs from a vehicle title. Extraction models may, in some examples, be trained to extract data from several types of documents. In some examples, text extraction may include other types of text recognition, such as optical character recognition (OCR), intelligent character recognition (ICR), and the like. In other embodiments, a bitmap may be used to extract unstructured and/or structure text.

In some embodiments, text extraction 212 may extract a binary decision from a field, such as a signature field, a check box, or a radio button. For example, with a signature field, text extraction 212 may determine a document is signed (e.g., a signature is present) or is not signed (e.g., a signature is not present). In another example, text extraction 212 may determine a form field (e.g., a check box or a radio button) is selected or is not selected.

In various embodiments, memory 200 may store instructions for data normalization 214. Data normalization 214 may generally utilize extracted data to generate structured data. The structured data may generally correspond to fields within the documents. The structured data generated by data normalization 214 may represent the values for the data most likely to be correct based on a hierarchy of documents within a document package.

Data normalization 214 may receive extracted text from text extraction 212 and may normalize the extracted text using various models, external data sources, and the like. For example, an extracted postal address may be normalized using the United States Postal Service database. Some extracted text (e.g., data types) may be normalized using various machine learned models, including generative models. For example, a large language model may be prompted to determine which portions of an extracted full name are most likely to be the first, middle, and last name.

To generate the structured data, data normalization 214 may utilize various industry specific logic and document hierarchies to determine which data is correct across the documents in the document package. In various examples, such document hierarchies may be user defined. Document hierarchies may further include transaction specific weighting based on weighted values for the different documents that include the data. For example, in a vehicle sale, the vehicle identification number (VIN) is most likely to be correct on the vehicle title. Data normalization may, accordingly, pull the VIN from the title and verify that the VIN pulled from the vehicle title is a valid number. For example, industry specific logic or algorithms may check that the VIN is the expected number of digits. Where the VIN on the vehicle title is not valid, data normalization 214 may pull the VIN from the next document in the hierarchy and check the validity of the next VIN pulled from the next document in the hierarchy. Once a valid VIN is found, that VIN may be included in the structured data. A similar process may be repeated for other data fields and types included in the documents of the document package.

In various embodiments, memory 200 may store instructions for auditing 216. Auditing 216 may generally receive the structured data from data normalization 214 and may locate any errors within the documents and/or the document package. In some examples, the structured data may be received from another source (e.g., uploaded by a user). Such structured data may be, in various examples, a transaction record. In various examples, auditing 216 may locate such errors through a combination of automated processes and guided review (e.g., providing instructions to users for review of documents).

Auditing 216 may present structured auditing questions to a user of the auditing system 102. Generally, structured auditing questions may guide a user's review of the documents and may verify that automated processes of the auditing system 102 correctly identified an error in one or more documents of the document package. For example, structured auditing questions may instruct a user to verify that certain information matches across documents, is logically correct, is present in the documents, or the like. For example, for a vehicle sale, a structured auditing question may instruct a user to verify that the odometer readings are in a logical order. Such structured auditing questions generally guide a user through the auditing process, such that audits can be completed by users with less or no formal training in the auditing process. The structured auditing questions may further speed up the auditing process when compared to a manual audit of a transaction package.

In some embodiments, auditing 216 may utilize automated programmatic verification to identify errors in documents of the document package. Such programmatic verification may include various industry or transaction specific comparisons. For example, programmatic verification may include verifying that certain fields match across documents in the document package. For example, in a vehicle transaction, such verification may include verifying that the fields on the title application match the corresponding fields on the title. In some examples, some fields may be specified as fields that need to match exactly. For example, a VIN on the title application must match the VIN on the title or the auditing system 102 notifies the user of an error. Some fields may be specified as fields where a partial match is sufficient. For example, a customer name on a sales tax receipt may partially match the name on the vehicle title. Fuzzy matching or other logic may be utilized to determine whether such fields match sufficiently.

In various examples, auditing 216 may utilize information from external sources to audit transaction documents. For example, auditing 216 may access databases provided by a state, organization, municipality, or other entity to cross check information. For example, a database associated with a state may be utilized to verify that a driver's license number matches the name in the transaction documents.

Auditing 216 may further include or utilize risk tolerance thresholds to determine whether an end user should be notified of an error identified by the system. For example, the risk threshold may specify types of errors that do not need to be presented to a user. Such errors may include, in various examples, partial matches across data fields that have been deemed acceptable for a particular industry and/or by an administrator or user of the auditing system 102. Such errors may be errors or inconsistencies in the original documents, errors due to OCR or ICR (e.g., difficulties in parsing handwritten text), or the like. Other types of errors may be flagged for user review. For example, in a vehicle transaction, where a VIN does not match in a title and title application, the error may be flagged for a user for correction or other action.

In various embodiments, memory 200 may store instructions for user interface (UI) configuration 218. UI configuration 218 may generally configure user interfaces to the auditing system 102. Such interfaces may be displayed, in various examples, at user interfaces of user devices accessing the auditing system 102, such as user interface 220 of the user device 104. UI configuration 218 may communicate with other components of the auditing system 102 to provide information received via user interfaces and/or to obtain information to be presented via various user interfaces. For example, UI configuration 218 may communicate with auditing 216 to present errors

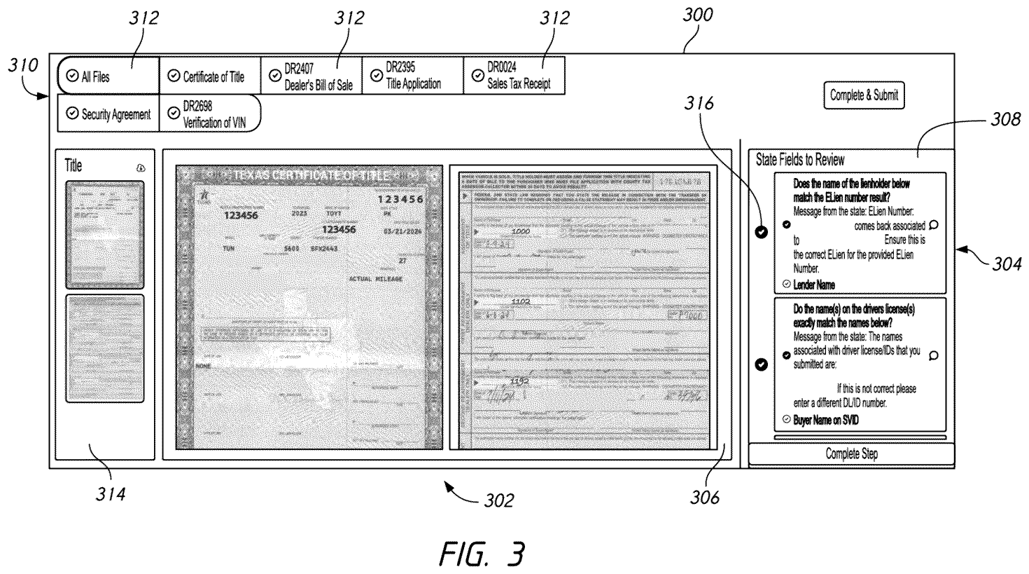

FIGS. 3-11 illustrate various example user interfaces of the auditing system 102. In various examples, such interfaces may be generated by UI configuration 218 and transmitted to a user device for display at the user device, such as through user interface 220 of the user device 104. Each of the user interfaces may generally be utilized to display information from, and/or provide information to, the auditing system 102.

FIG. 3 illustrates a user interface 300 of the auditing system 102 according to an embodiment of the disclosure. The user interface 300 generally displays one or more documents 302 in the document package along with structured auditing questions 304 generated by auditing 126. For example, a structured auditing question in the user interface 300 may instruct the user to verify that a dealer name as listed in the document 302 exactly matches a dealer name associated with a provided dealer number. Using the user interface 300, a user may view and respond to structured auditing questions 304 provided by the auditing system 102. The structured auditing questions 304 are provided next to the documents 302 such that a user may easily review the documents 302 while viewing the structured auditing questions 304. In some embodiments, the document or documents 302 are displayed in a window or pane 306 and the structured auditing questions 304 are displayed in another pane 308. The user may navigate between documents 302 using a document menu 310. A user may select a tab 312 (e.g., click on or tap a tab 312) in the document menu 310 to cause the document to be displayed in the pane 306. Additionally or alternatively, links or images of the documents may be displayed in a pane 314. The user may select a document in the pane 314 (e.g., click or tap on the document) to cause the document to be displayed in the pane 306.

In various examples, the structured auditing questions 304 presented may be varied based on one or more factors such as the type of transaction, the types of data in the transaction, the types of documents in the transaction, the documents needed to complete a document package, or the like. Further, the structured auditing questions 304 may be presented in a manner intended to draw a user's attention to specific pieces of data for confirmation. For example, a green check mark 316 may indicate a field that the auditing system 102 was able to identify as correct, while a red exclamation point (not shown) may indicate a field that the auditing system 102 identified as incorrect, where additional user review is required.

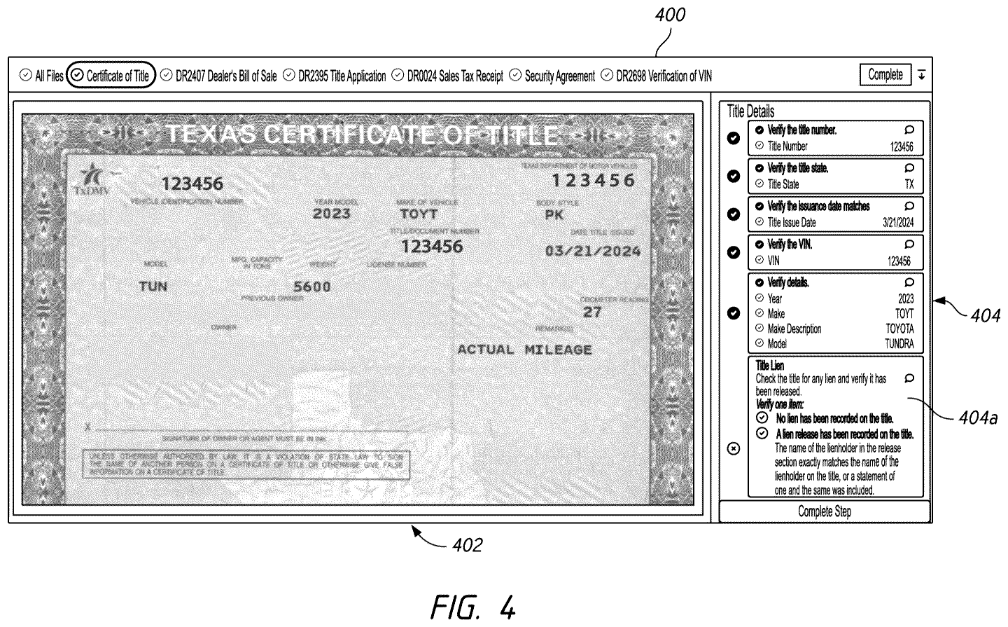

FIG. 4 illustrates a user interface 400 of the auditing system 102 according to an embodiment of the disclosure. The user interface 400 displays a document 402 in a document package along with structured auditing questions 404 related to the document and generated by auditing 216. For example, the structured auditing questions 404 shown in the user interface 400 may direct a user to verify that structured data extracted from the document by the auditing system 102 matches the data in the document 402. Structured auditing questions 404 shown in the user interface 400 may further direct the user to check other information on the document aside from verifying structured data. For example, a structured auditing question 404a shown in the user interface 400 directs a user to determine whether there is a lien recorded on the title and if so, whether a lien release has been recorded on the title. Other such structured auditing questions may be presented via user interfaces to the auditing system 202 and may, in various examples, be transaction specific.

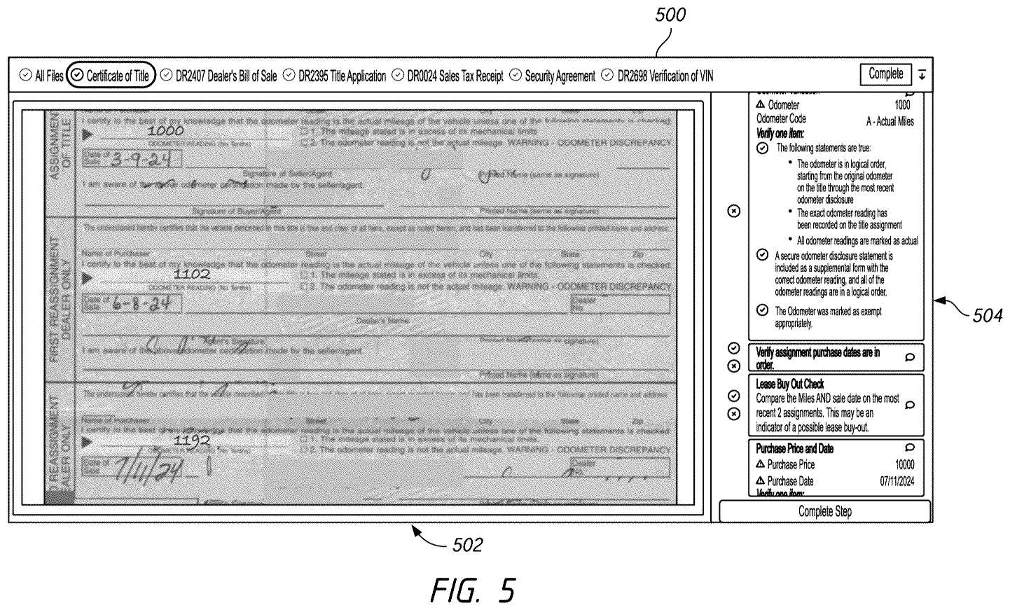

FIG. 5 illustrates a user interface 500 of the auditing system 102 according to an embodiment of the disclosure. Like the user interfaces 300 of FIG. 3 and 400 of FIG. 4, the user interface 500 shows a document 502 of a document package along with structured auditing questions 504 related to the displayed document 502.

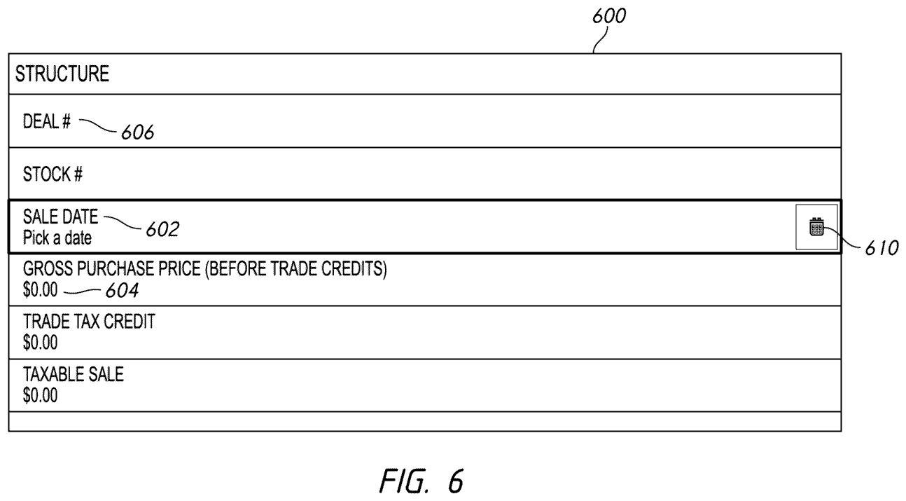

FIG. 6 illustrates a user interface 600 of the auditing system 102 according to an embodiment of the disclosure. The user interface 600 may be an initial user interface displayed to a user before a document package is uploaded to the auditing system 102. As shown in the user interface 600, a user may, in various examples, provide information before uploading a document package that can be used by the auditing system 102 to generate structured data. In some examples, a user may manually enter a date of sale 602, a purchase price 604, a deal number 606, or the like to the auditing system 102 to be associated with a transaction. The user may manually enter the data (e.g., the date of sale 602, the purchase price 604, and/or the deal number 606) using input elements, such as text boxes or voice inputs. In some embodiments, the user may enter a date (e.g., the date of sale 602) using, for example, a calendar icon or date picker 610. Once the document package associated with the transaction is uploaded, such information may be utilized as a ground truth when generating structured data for the document package. Generally, the user interface 600 may allow for manual creation of a transaction or an automated creation of the transaction by extracting information from uploaded documents.

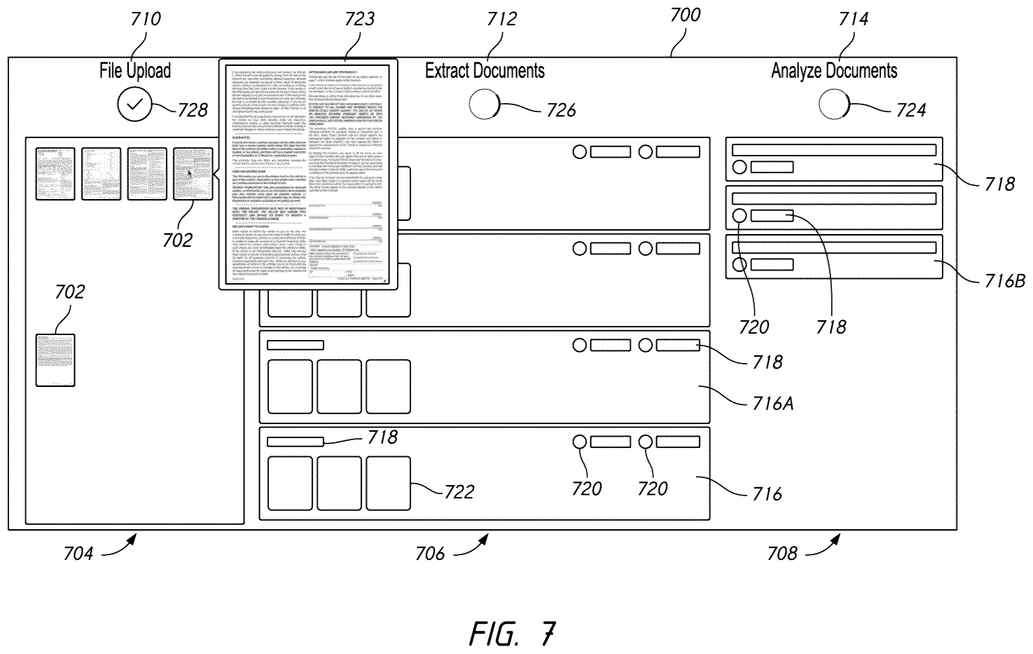

FIG. 7 illustrates a user interface 700 of the auditing system 102 according to an embodiment of the disclosure. The user interface 700 may be displayed to a user while a document package is uploading to the auditing system 102. The user interface 700 may display one or more previews 702 of pages of a document package as the document package is uploaded to the auditing system 210. In some embodiments, a preview 702 of each document may be displayed after each document is extracted. Accordingly, a user may visually verify that the document package is being correctly uploaded (e.g., that the pages look as the user expects, that the correct document package is being uploaded, or the like). In some embodiments, a preview 702 may be displayed in a reduced format (e.g., a smaller size and/or a lower-resolution version of the document) or in a larger format (e.g., a larger size and/or a higher resolution version). For example, a preview 702 may be displayed as a thumbnail image or as a full-size image of the document.

In some embodiments, the user interface 700 may display one or more procedures to be performed, that are in process, and/or that are completed in different cards or panels 704, 706, 708. In the example embodiment of FIG. 7, the procedures of File Uploading 710, Document Extraction 712, and Analyze Documents 714 are shown in the panels 708, 706, 704, respectively. In one embodiment, the Document Extraction 712 procedure includes the process of separating the document package into individual pages, and the analyze documents 714 procedure may include a classification process, a text extraction process, a generation of structured data process, an audit process, or combinations thereof. These processes are described in more detail later.

One or more of the panels 704, 706, 708 may display an entry or a listing 716 for each document or page of a document in the document package. For example, the panel 704 and the panel 706 may display one or more listings 716, with each listing 716 including a description 718 of the document or page. Each listing 716 may further include one or more indicators, such as indicator 720, that may display a status of the procedure for that listing 716. The indicator 720 may be implemented as a visual status indicator. For example, in the illustrated embodiment, the listings 716A in the panel 706 and the listing 716B in the panel 708 display a circle status indictor 720 that may be blank when a procedure to be performed on that listing 716 is awaiting initiation, that may be partially filled when the procedure on that listing 716 is in process, and that may be filled (e.g., with a check or a solid color) when the procedure on that listing 716 is completed.

The panel 706 may display a representation 722 for each document and/or page of a document that is extracted. In some embodiments, the panel 704 may display previews 702 of the documents and/or the pages of the documents during uploading of the document package or when the uploading of the document package is completed. A user may select a preview 702 (e.g., click on or tap) to cause the enlarged preview 723 to be displayed.

The user interface 700 may display one or more status indicators during uploading and/or after the document package is uploaded. For example, in the illustrated embodiment, a status indicator 724 indicates the Analyze Documents procedure 714 is in process, another status indicator 726 indicates the Extract Documents procedure 712 is in process, and another status indicator 728 indicates completion of the File Upload procedure 710. In some embodiments, the visual status indicators 724, 726, 728 may be updated in real time to indicate a status of the procedure. For example, the visual status indicator 724 reflects the initiation of the analysis of the documents and the visual status indicator 726 reflects the initiation of the Extract Documents procedure 712 (e.g., the analysis 714 and the extraction 712 procedures are in process). The status indicator 728 reflects the completion of the file upload procedure 710. The visual status indicators 724, 726, 728 may change as the procedures continue to be performed over time. For example, as shown in the user interface 700, progress of the Extract Documents procedure 712 and the Analyze Documents procedure 714 may be shown through a change to the visual appearance of the visual status indicators 724, 726. For example, a change in weight of the outline of the visual status indicator 724, 726 and/or color of the visual status indicators 724, 726 may change over time. For example, a visual status indicator with no outline or a lightweight outline may indicate the procedure has not begun. The outline of the visual status indicator 724, 726 may look different depending on the stage of procedure. For example, the visual status indicator 724 may show that the Analyze Documents procedure 714 is in process and is approximately 25% complete (e.g., approximately 25% of the outline is a heavier weight). The visual status indicator 728 may show that the File Upload procedure 710 is complete (e.g., all of the outline is a heavier weight). In other examples, different types of visual status indicators, such as timers, progress bars, and the like may be used to show the progress of a procedure. In some embodiments, a shape and/or a design of the visual indicator may change. For example, a shape or a design that is blank may change to a checkmark or a shape with a colored checkmark.

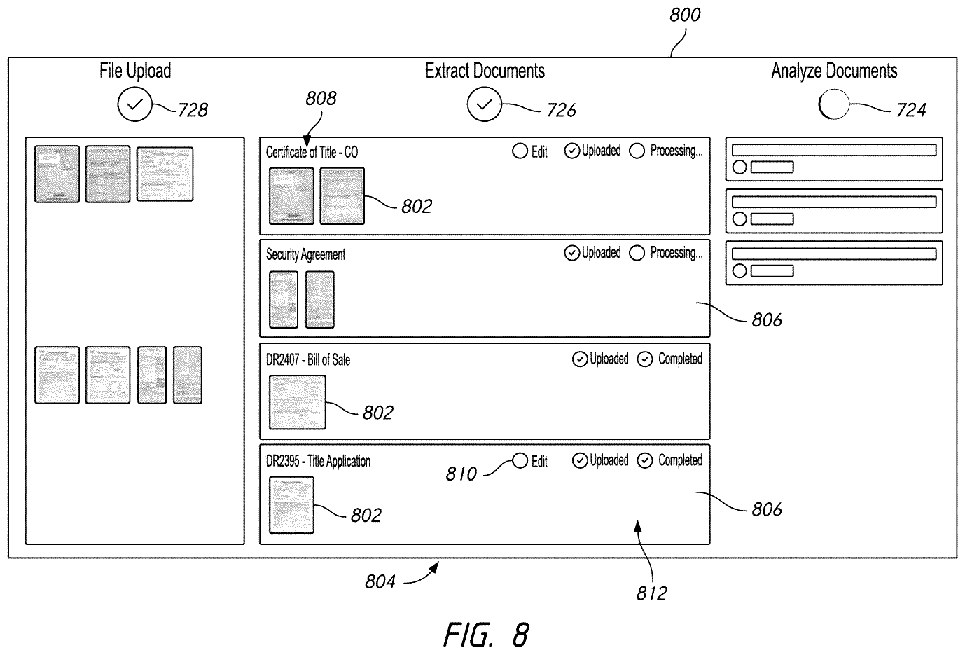

FIG. 8 illustrates a user interface 800 of the auditing system 102 according to an embodiment of the disclosure. The user interface 800 may be displayed after a document package is uploaded to the auditing system 102, such as while document processing 210 (FIG. 2) is splitting the document package into individual documents or pages as part of an Extract Documents procedure. For example, the user interface 800 displays previews 802 of pages that have been classified as certain types of documents. The previews 802 are arranged by document type. The different types of documents may be displayed in a list 804. In some embodiments, the list 804 may be displayed in the panel 706 shown in FIG. 7. For example, as shown in FIG. 8, each listing 806 of a document type in the list 804 includes a title or a description 808 and the preview 802. The preview 802 may be implemented as the preview 702 shown in FIG. 7.

In some examples, the user interface 800 may include additional selectable elements 810 such that a user may correct the classification of various documents before the auditing system 102 proceeds to auditing of the documents. Additionally or alternatively, the user interface 800 may include one or more status indicators 812. In some embodiments, at least one of the one or more status indicators 812 may be implemented as visual status indicators that change in real time (e.g., similar to visual status indicators 724, 726, 728).

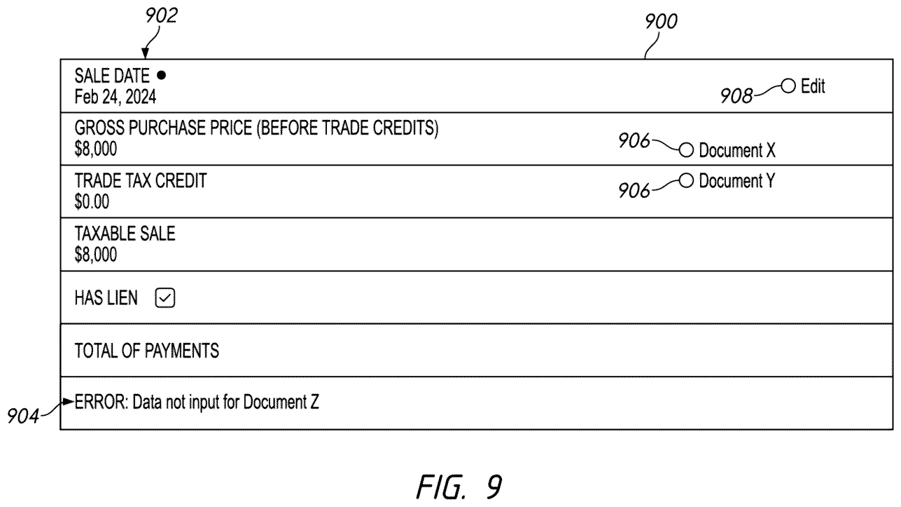

FIG. 9 illustrates a user interface 900 of the auditing system 102 according to an embodiment of the disclosure. The user interface 900 generally displays structured data 902 that is produced using the extracted text (e.g., the unstructured and/or structured text extracted from documents in the document package). For example, the user interface 900 may be displayed after text extraction 212 of FIG. 2 extracts extracted text from the documents and data normalization 214 of FIG. 2 generates the structured data for the document package. In some examples, the user interface 800 may further display errors 904 in the document package, such as missing data fields, missing documents, and the like. The user interface 900 may further include selectable elements allowing a user to upload missing documents (e.g., selectable elements 906), edit structured data 902 (e.g., selectable element 908), and/or otherwise correct errors in the structured data or document package before the auditing process begins. The user interface 900 may further display how documents and/or pages within a document package have been separated or classified by document processing 210 of FIG. 2.

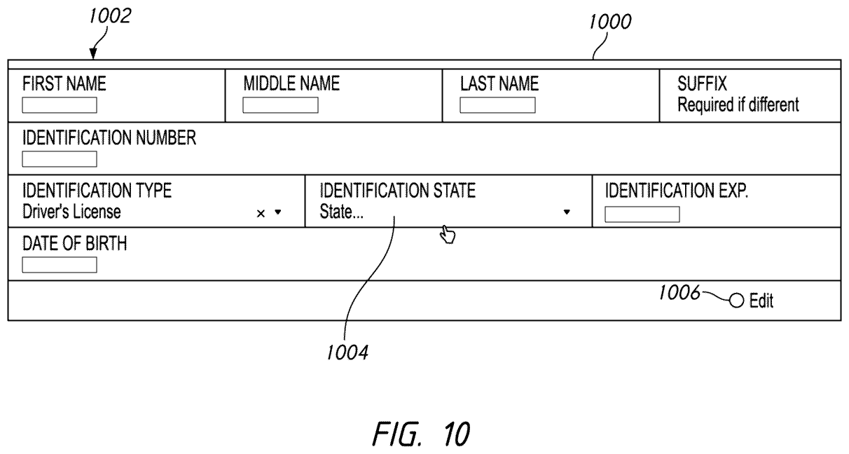

FIG. 10 illustrates a user interface 1000 of the auditing system 102 according to an embodiment of the disclosure. The user interface 1000 may be, in some examples, displayed with the user interface 900 shown in FIG. 9. For example, the user interface 1000 displays additional structured data 1002 that is based on the text extracted from the document package and normalized across the documents. As shown, the user interface 1000 may include editable fields 1004 or other selectable elements 1006 allowing a user to edit the structured data 1002, provide missing data, or otherwise correct errors or inconsistencies in the documents of the document package. For example, a user may manually correct or enter data using the user interface 1000. In some examples, such errors or inconsistencies may be identified by the auditing system during document processing, text extraction, and/or data normalization. Accordingly, the auditing process may be completed with complete and more accurate data.

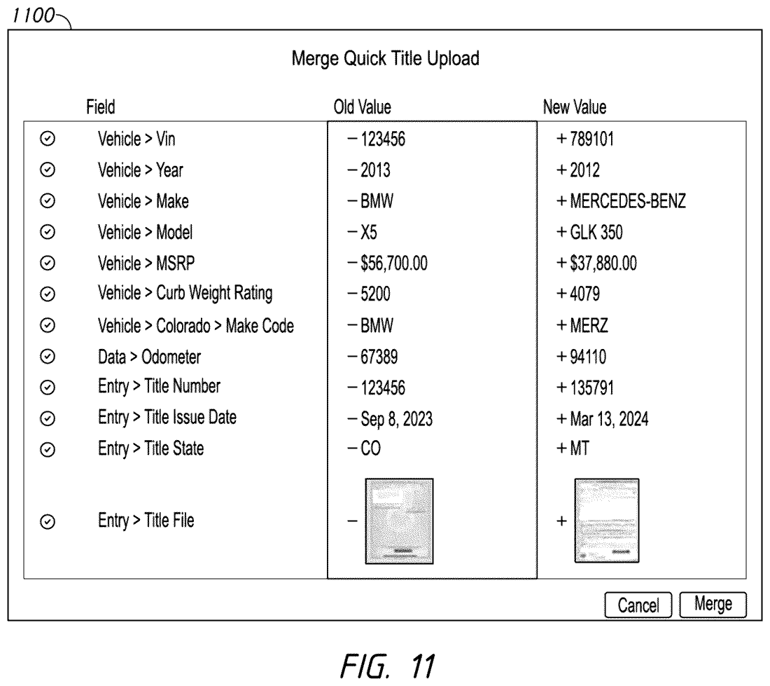

FIG. 11 illustrates a user interface 1100 of the auditing system 102. The user interface 1100 may generally show a user interface that may be displayed at a user device before merging changes into a document package. For example, the user interface 1100 may be displayed after a user uses the user interface 900 of FIG. 9 and/or the user interface 1000 of FIG. 10 to upload corrected documents, edit structured data fields, or the like. For example, the user interfaces 900 or 1000 may reflect that the wrong title was uploaded to the auditing system 102 (e.g., the information in the data fields of the title did not match information in corresponding data fields of other documents in the document package). The user interface 1100 may then display data extracted from the newly uploaded title. The user may confirm that the new title should be uploaded and merged into the document package before the auditing process for the document package. The user interface 1100 may further allow the user to confirm whether new information should be merged into a document package. For example, the user may be asked to confirm, via the user interface 1100 that the new value should be used.

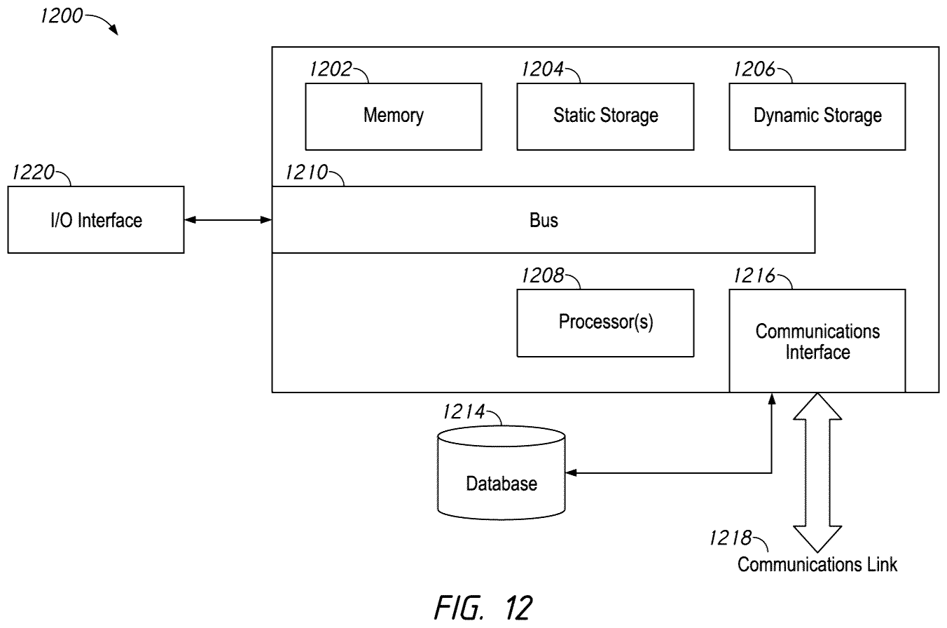

The auditing system 102 may be implemented using various computing systems. Turning to FIG. 12, an example computing system 1200 may be used for implementing various embodiments in the examples described herein. For example, the auditing system 102 shown in FIG. 1 and/or FIG. 2 and various components of the auditing system 102 may be located at one or several computing systems 1200. In various embodiments, a user device 104 (FIG. 1) is also implemented by a computing system 1200. This disclosure contemplates any suitable number of computing systems 1200. For example, the computing system 1200 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 1200 may include one or more computing systems; be unitary or distributed; span multiple locations; span multiple machines; span multiple data centers; or reside in a cloud, which may include one or more cloud components in one or more networks.

Computing system 1200 includes a bus 1210 (e.g., an address bus and a data bus) or other communication mechanism for communicating information, which interconnects subsystems and devices, such as processor 1208, memory 1202 (e.g., RAM), static storage 1204 (e.g., ROM), dynamic storage 1206 (e.g., magnetic or optical), communications interface 1216 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), and an input/output (I/O) interface 1220 (e.g., keyboard, keypad, mouse, microphone). In particular embodiments, the computing system 1200 may include one or more of any such components.

In particular embodiments, processor 1208 includes hardware for executing processor-executable instructions, such as those making up a computer program. The processor 1208 circuitry includes circuitry for performing various processing functions, such as executing specific software for performing specific calculations or tasks. In particular embodiments, I/O interface 1220 includes hardware, software, or both providing one or more interfaces for communication between computing system 1200 and one or more I/O devices. Computing system 1200 may include one or more of these I/O devices, where appropriate. One or more of these devices may enable communication between a person and computing system 1200.

In particular embodiments, communications interface 1216 includes hardware, software, or both providing one or more interfaces for communication (such as, for example, packet-based communication) between computing system 1200 and one or more other computer systems or one or more networks. One or more memory buses (which may each include an address bus and a data bus) may couple processor 1208 to memory 1202. Bus 1210 may include one or more memory buses, as described below. In particular embodiments, one or more memory management units (MMUs) reside between processor 1208 and memory 1202 and facilitate access to memory 1202 requested by processor 1208. In particular embodiments, bus 1210 includes hardware, software, or both coupling components of the computing system 1200 to each other.

According to particular embodiments, computing system 1200 performs specific operations by processor 1208 executing one or more sequences of one or more instructions contained in memory 1202. For example, instructions for document processing 210, text extraction 212, data normalization 214, auditing 216, and/or UI configuration 218 of FIG. 2 may be contained in memory 1202 and may be executed by the processor 1208. Such instructions may be read into memory 1202 from another computer readable/usable medium, such as static storage 1204 or dynamic storage 1206. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 1208 for execution. Such a medium may take many forms, including but not limited to nonvolatile media and volatile media. Non-volatile media includes, for example, optical or magnetic disks, such as static storage 1204 or dynamic storage 1206. Volatile media includes dynamic memory, such as memory 1202.

Computing system 1200 may transmit and receive messages, data, and instructions, including program, e.g., application code, through communications link 1218 and communications interface 1216. Received program code may be executed by processor 1208 as it is received, and/or stored in static storage 1204 or dynamic storage 1206, or other storage for later execution. A database 1214 may be used to store data accessible by the computing system 1200 by way of communications interface 1216. For example, interface data 206 and auditing data 216 shown in FIG. 2 may be stored using a database 1214. In various examples, communications link 1218 may communicate with, for example, user devices to allow users to access the auditing system 102.

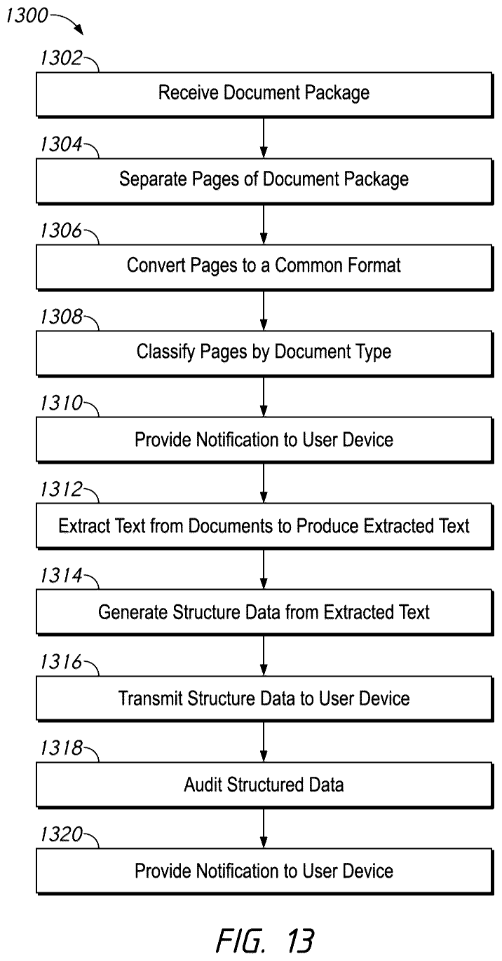

FIG. 13 illustrates an example process 1300 for identifying and auditing a document package using the auditing system 102 according to an embodiment of the disclosure. Initially, at block 1302, a document package is received. The document package may be received at an auditing system from a user device, such as the user device 104 in FIG. 1. The document package may include a plurality of documents associated with a transaction, which may be a financial transaction, sales transaction, or the like. The document package may be received as a bundled document package (all documents together) or the documents in the document package may be uploaded at different times. In some embodiments, one or more of the user interfaces 600, 700, and/or 800 shown in FIGS. 6-8, respectively, may be transmitted to a user device before, during, and/or after the document package is uploaded to the auditing system.

At block 1304, the document package is separated into individual pages. In one embodiment, the auditing system may use page boundaries to locate the individual pages within the document package. For example, document processing 210 shown in FIG. 2 may use page boundaries to locate the individual pages within the document package.

In some examples, the documents in the document package may be in different formats. For example, some documents may be in image formats (e.g., JPEG or GIF) while other documents may be in a text format or a document file format (e.g., PDF format). In such examples, some or all of the individual pages are converted to a common format at block 1306. In one embodiment, document processing 210 may convert some or all of the documents to an image format.

At block 1308, the individual pages are classified by document type. The classification of the pages may generally categorize and group the pages as a particular type of document. The individual pages within the document package (that may be in the common format) may generally be processed and classified by document processing 210 of FIG. 2. In some embodiments, one or more image classifiers may be used to determine (e.g., classify) what type of document each page belongs to. In some examples, such image classifiers may be trained to be transaction specific to identify the types of documents that are expected to be in a document package for a particular type of transaction. For example, an image classifier may be trained to recognize various documents likely to be included in a document package associated with a sale of a vehicle in a particular state.

As image classifiers may be trained to recognize individual pages, the auditing system (e.g., document processing 210) may be able to process and categorize documents when pages of a document are out of order within a document package and may be able to identify duplicates, missing pages, missing documents and/or other threshold issues with document packages. In such situations, the auditing system 102 may transmit a notification to a user device to notify the user of such issues at block 1310. For example, the user interface 900 of FIG. 9 may be transmitted to the user device.

In some examples, the auditing system 102 may display various user interfaces as documents are processed and classified. For example, the user interface 700 of FIG. 7 and/or the user interface 800 of FIG. 8, and/or similar user interfaces may be transmitted to a user device and displayed to a user as documents are processed to show the types of documents that have been extracted or categorized from the document package. In some examples, the user may be able to correct any errors in document categorization via one or more user interfaces (e.g., user interfaces 700, 800, and/or 900 of FIGS. 7-9 respectively).

At block 1312, text (e.g., structured and/or unstructured text) is extracted from the documents to produce extracted text. In various examples, text may be extracted using extraction algorithms trained to extract unstructured and/or structured text from various types of documents. In one embodiment, key value pairs may be used to extract text. The extraction algorithms may use rules, models, or artificial intelligence (AI) to detect key value pairs. A “key”, such as a label or identifier, is associated with a corresponding “value”, or the data associated with the key. One example of a key value pair is “Name: John Doe”, where “Name” is the key and “John Doe” is the value. The extraction algorithms may be custom algorithms that are trained to extract key value pairs from various types of documents. Specifically, such algorithms may be trained to extract data from specific fields of various documents. In some examples, such extraction algorithms may be specific to a document type. For example, an extraction algorithm may be trained to extract particular key value pairs from a vehicle title. The extraction model(s) may, in various examples, utilize trained AI extractors to extract label data value from documents. For example, AI extractors may utilize OCR, ICR, or other algorithms to recognize and extract text in particular types of documents. In some examples, multiple AI extractors may be used, with each extractor being trained to extract data from a particular type of document. In other embodiments, raw text may be extracted and analyzed to determine conclusions regarding the raw text, or one or more bitmaps may be generated or used to extract text. Additionally or alternatively, a binary decision from certain types of fields, such as a signature field or a form field, may be extracted.

At block 1314, structured data is generated using the extracted text. The structured data may be generated by normalizing data across the transaction documents. For example, key value pairs corresponding to data fields in the transaction documents may be extracted and the data may be normalized across the documents. In one embodiment, data normalization 214 of FIG. 2 may compare values across the documents to identify a value most likely to be correct. The identified value may then be included in the structured data.

In some embodiments, data normalization may normalize particular data fields to match specific formats. For example, a large language model or other machine learning model may be used to format a name (e.g., to determine which part of a name is the first name, middle name, last name, suffix, and the like). In another example, an address database or other external service may be used to verify and normalize addresses extracted during text extraction.

The normalization of the extracted text may be normalized by applying extraction algorithms (e.g., models) related to a hierarchy of the documents for corresponding document fields. For example, a key may be associated with multiple values for a VIN in a transaction for sale of an automobile. The hierarchy of the documents may specify that the VIN on the title to the vehicle is controlling. That is, the VIN on the title is most likely to be correct and will be included in the structured data.

In some examples, the auditing system may perform some verification along with applying hierarchical rules to generate structured data. For example, the auditing system (e.g., data normalization 214) may perform basic checks to ensure that a VIN is valid (e.g., the VIN is the right number of digits, the VIN is assigned to a vehicle in a database, and the like). Where the VIN on the title is not valid, the auditing system may instead include in the structured data a VIN from the next document in the hierarchy, such as a title application. The incorrect VIN on the title may then be flagged for user review during the auditing process. Similarly, a sale price may be verified across documents by, for example, adding up the total of payments in a payment schedule to determine whether the total payments total the purchase price or financed price.

At block 1316, the structured data may be transmitted to a user device. For example, in one embodiment, the user interface 900 shown in FIG. 9, the user interface 1000 shown in FIG. 10, and/or the user interface 1100 shown in FIG. 11 may be transmitted to a user device. As described previously, the user interface(s) 900, 1000 may be configured to receive inputs to add additional documents, correct any errors, and so on.

At block 1318, the transaction documents are audited using the structured data. In one embodiment, the transaction documents may be audited using a combination of structured auditing questions and automated programmatic checks. For example, structured auditing questions may be presented to a user (e.g., through user interfaces such as user interfaces 300, 400, and/or 500 of FIGS. 3-5, respectively). Such structured auditing questions may be industry specific and/or specific to the type of transaction associated with the transaction documents. A user may provide answers to the structured auditing questions and the auditing system 102 may identify errors in the documents based on answers to the structured auditing questions. Additionally or alternatively, the auditing system 102 may perform automated programmatic verification to, for example, verify that values for document fields are consistent across documents. The auditing system 102 may identify additional errors in the documents based on such programmatic verification. In some embodiments, the auditing system may access external sources when auditing the transaction documents. For example, the auditing system may access one or more databases provided by a state, an organization, a municipality, or other entity to cross check information. In various examples, identified errors may be highlighted for the user based on risk tolerance thresholds.

At block 1320, a notification is transmitted to a user device based on the auditing of the structured data at block 1318. The notification may, for example, may include a message that the auditing was successful. In some instances, the notification may provide additional information about the auditing process, such as a report that includes the document package that was received at block 1302. Additionally or alternatively, the notification may include errors that were highlighted during the auditing process. The errors may include the risk tolerance thresholds.

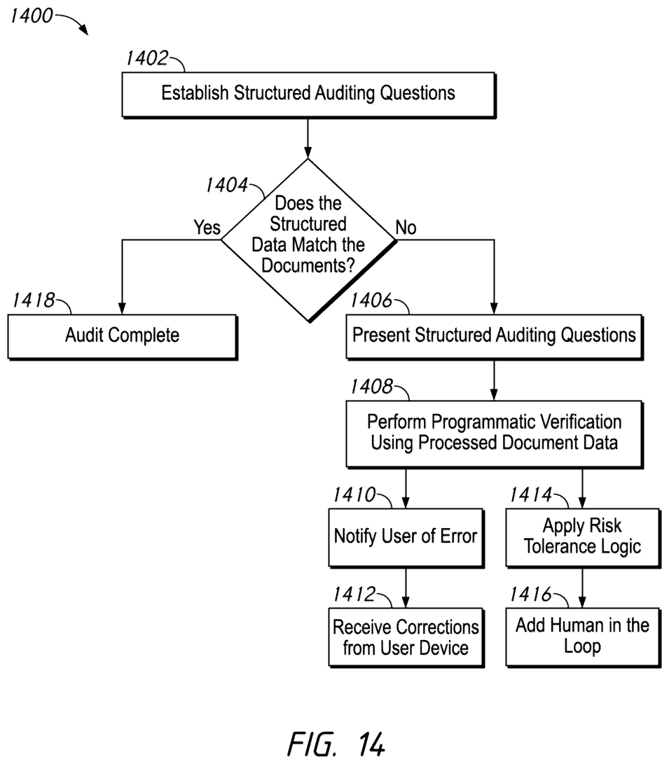

FIG. 14 illustrates an example process 1400 for auditing a document package using the auditing system 102 according to an embodiment of the disclosure. Generally, the process 1400 may begin with structured data produced using extracted text. The structured data may be received, for example, from data normalization 214 of FIG. 2. In some examples, structured data may instead be obtained from a transaction record. In various examples, the process 1400 may be repeated for individual pieces of data within the structured data. For example, one iteration of the process 1400 may verify a VIN across documents, while another iteration of the process 1400 may verify a customer name across documents in a document package.

In some examples, the process 1400 may include a determination that structured auditing questions should be presented to a user based on an initial automated audit of the document package. For example, a document package may be audited using an automated process to analyze structured data extracted from the documents. Where the automated process is able to verify the document package (e.g., that there are no errors in the document package or that the errors are within a specified risk tolerance), the process 1400 may not proceed. In such examples, the process 1400 may proceed for user review where there are errors in the document package, or when such errors do not fall within a specified risk tolerance, such that the transaction would benefit from a human in the loop.

At block 1402 structured auditing questions are established. The structured auditing questions may be the questions to be evaluated and may vary based on the document type and the transaction type. For example, some structured auditing questions may direct a user to review or verify particular data fields within a document or across multiple documents in a document package. For example, the structured auditing questions may ask a user to look at the documents and verify that the structured data matches information on the documents. Such structured auditing questions may be helpful for identifying errors in the text extraction process and may provide an additional layer of review where, for example, documents in the document package include handwritten or otherwise less legible information (e.g., when documents are scanned into the system). Structured auditing questions may further direct users to review the documents in the document package for logical inconsistencies. For example, a user may be asked to verify that mileage on a vehicle increases or remains constant as various documents in the document package are in ascending order as the documents progress in date.

At decision 1404, the auditing system 102 determines if the structured data matches the documents. The auditing system 102 may determine whether the structured data matches the documents based on an analysis of the documents. For example, the auditing system 102 may determine whether structured data matches the document based on one or more automated verification processes. When the structured data does match the documents, the process ends with completion of the audit at block 1418.

When the structured data does not match the documents, the structured auditing questions may be presented (block 1406). The structured auditing questions may be presented via a user interface configured by UI configuration 218 of FIG. 2. For example, user interface 300 shown in FIG. 3, the user interface 400 shown in FIG. 4, the user interface 500 shown in FIG. 5, and various combinations thereof may be provided to the user device to display the structured auditing questions alongside the documents being audited. Generally, structured auditing questions may enable more efficient review and auditing of documents by various users, including those with less experience in auditing. In various examples, the structured auditing questions may be specific to an industry or type of transaction or transaction documents

At block 1408, programmatic verification is performed. Generally, the programmatic verification is performed using process document data. Programmatic verification may be automated and may be based on industry specific questions, hierarchies, and risk thresholds. Generally, programmatic verification may verify that data in corresponding data fields across documents matches the structured data. In some examples, some fields may not need to match exactly in order to be verified as being correct across documents. For example, a name with a spelled out middle name may be considered matching a name with a middle initial. Fuzzy matching or other algorithms may be utilized for such comparisons.

Where an error is found, the user is notified of an error at block 1410 and the user may correct the structured data at block 1412. For example, a user may be notified of an error via a user interface configured by UI configuration 218 of FIG. 2. UI configuration 218 may transmit the user interface 900 shown in FIG. 9 and/or the user interface 1000 shown in FIG. 10 to the user device 104 for display in the user interface 220. Where the structured data is incorrect and the error stems from the incorrect structured data, the user may correct the structured data via a user interface to the auditing system 102. Where there are errors within the originally uploaded documents in the document package, the user may correct and upload corrected documents to the system.

Where an error is found, a risk tolerance logic may be applied at block 1414, and a human may be added in the loop at block 1416. For example, risk tolerance logic may specify that some errors do not need to be reported based on the level of risk tolerance acceptable in an industry, by the user, or the like. Using such risk tolerance logic may reduce the number of audits that use a human in the loop, further increasing auditing efficiency using the auditing system 102.

According to the above examples, the auditing system 102 provides for streamlined and improved auditing of transaction documents. For example, the auditing system 102 may provide more efficient audits when compared to manual audits, allowing for more transactions to be audited and for more errors to be identified.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Further, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples, and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A computer-implemented method comprising:
receiving, from a computing device, a transaction package including a plurality of documents associated with a single transaction;
separating the plurality of documents into individual pages;
converting at least a portion of the individual pages into a common format;
classifying the individual pages by document type;
extracting text from at least a portion of the individual pages as classified by document type to produce extracted text, wherein extracting the text comprises using one or more extraction algorithms trained to extract text from documents associated with the document type;
generating structured data from the extracted text by normalizing data corresponding to data fields across the individual pages; and
prior to separating the plurality of documents into the individual pages, transmitting a user interface to a computing device, the user interface configured to display:
a preview of each of the individual pages;
the previews of the individual pages arranged by document type.

2. The computer-implemented method of claim 1, further comprising auditing the plurality of documents using the structured data, wherein auditing the documents comprises:
presenting, in the user interface, one or more structured auditing questions;
receiving, from the computing device, user inputs based on the structured auditing questions, at least one of the user inputs verifying the structured data matches data in the plurality of documents; and
transmitting, to the computing device, a notification when structured data does not match the data in at least one of the plurality of transaction documents.

3. The computer-implemented method of claim 1, wherein the user interface is configured to display at least one visual status indicator for at least one of the separating or the classifying operation, wherein an appearance of the at least one visual status indicator changes between initialization of the at least one of the separating or the classifying operation and completion of the at least one of the separating or the classifying operation.

4. The computer-implemented method of claim 1, wherein the generating of the structured data comprises comparing text extracted from two or more of the plurality of transaction documents.

5. The computer-implemented method of claim 1, wherein the extracting of the text comprises extracting text using key value pairs that correspond to data fields in the plurality of documents.

6. The computer-implemented method of claim 1, wherein the single transaction is one of a mortgage transaction or a vehicle sale.

7. A computer-implemented method comprising:
receiving, from a computing device, a transaction package including a plurality of documents associated with a single transaction;
separating, by a processor, the plurality of documents into individual pages;
converting, by the processor, at least a portion of the individual pages into a common format;
classifying, by the processor, the individual pages by document type;
extracting, by the processor, text from at least a portion of the individual pages to produce extracted text, the extracting performed using one or more extraction algorithms trained to extract text from documents associated with the document type;
generating, by the processor, structured data from the extracted text by normalizing data corresponding to data fields across the individual pages; and
prior to separating the plurality of documents into the individual pages, transmitting a user interface to a computing device, the user interface configured to display:
a thumbnail image of each of the individual pages;
the thumbnail images of the individual pages arranged by document type; and
a visual status indicator for each of the separating operation and the classifying operation, wherein an appearance of each of the visual status indicators changes between initialization of the separating operation and the classifying operation and completion of the separating operation and the classifying operation.

8. The computer-implemented method of claim 7, further comprising:
identifying an error in the plurality of documents based on a response to a structured auditing question; and
presenting the error in the user interface based on the error exceeding a risk threshold.

9. The computer-implemented method of claim 7, further comprising auditing the plurality of documents using the structured data, wherein auditing the plurality of documents comprises:
presenting, in the user interface, one or more structured auditing questions;
receiving, from the computing devices, user inputs based on the structured auditing questions, at least one of the user inputs verifying the structured data matches data in the plurality of documents; and
transmitting, to the computing device, a notification when structured data does not match the data in at least one of the plurality of transaction documents.

10. The computer-implemented method of claim 9, further comprising transmitting a notification to the computing device upon a successful completion of the auditing of the plurality of documents.

11. The computer-implemented method of claim 7, wherein the extracting of the text comprises at least one of:
extracting the text using key value pairs that correspond to data fields in the documents; or
extracting a binary decision from at least one field in at least one document.

12. The computer-implemented method of claim 7, wherein:
classifying the plurality of documents associated with the transaction comprises classifying the plurality of documents associated with the transaction using a machine learning model trained to identify the plurality of types of documents associated with the transaction; and
the machine learning model comprises an image classifier.

13. The computer-implemented method of claim 7, wherein normalizing the extracted text across the plurality of documents comprises comparing the extracted text from two or more of the plurality of documents.

14. The computer-implemented method of claim 7, wherein the appearance of each of the visual status indicators changes by changing at least one of a color of the visual status indicators or a weight of an outline of the visual status indicators to indicate a status of the separating operation and the classifying operation.

15. A system, comprising:
one or more processors; and
one or more memories storing instructions that, when executed by the one or more processors, cause the system to perform operations, the operations comprising:
receiving a document package including a plurality of documents associated with a single transaction;
separating the plurality of documents into individual pages using page boundaries to locate the individual pages within the document package;
converting at least a portion of the individual pages into a common image format;
classifying the individual pages by document type;
extracting text from at least a portion of the individual pages as classified by document type to produce extracted text, wherein extracting the text comprises using one or more extraction algorithms trained to extract text from documents associated with the document type, the one or more extraction algorithms comprising an image classifier;
generating structured data from the extracted text by normalizing data corresponding to data fields across the individual pages; and
prior to separating the plurality of documents into the individual pages, transmitting a user interface to a computing device, the user interface configured to display:
a preview of each of the individual pages;
the previews of the individual pages by document type; and
a visual status indicator for each of the separating operation and the classifying operation, wherein an appearance of each of the visual status indicators changes between initialization of the separating operation and the classifying operation and completion of the separating operation and the classifying operation by changing at least one of a color of the visual status indicator or a weight of an outline of the visual status indicator.

16. The system of claim 15, wherein the one or more memories store further instructions for auditing the plurality of documents using the structured data, wherein auditing the plurality of documents comprises at least one of:
presenting one or more structured auditing questions in the user interface and responsively receiving user inputs; or
performing automated programmatic verification to verify that values for document fields are consistent across documents in the plurality of documents.

17. The system of claim 16, wherein auditing the documents further comprises:
verifying that the structured data matches data in the plurality of transaction documents;
identifying an error in a document in the plurality of documents; and
transmitting a notification to the computing device based on a risk tolerance threshold that is used to determine whether the notification should be transmitted to the computing device.

18. The system of claim 17, wherein:
the user interface is a first user interface; and
the one or more memories store further instructions for transmitting a second user interface to the computing device, the second user interface configured to display the structured data.

19. The system of claim 15, wherein the extracting of the text comprises at least one of:
extracting structured text using key value pairs that correspond to data fields in the plurality of documents; or
extracting unstructured text from the plurality of documents.

20. The system of claim 19, wherein the extracting of the text further comprises extracting a binary decision from at least one field in at least one document in the plurality of documents.
